(19) United States
(12) Patent Application Publication
(10) Pub. No.: US 2018/0166895 A1
(43) Pub. Date: Jun. 14, 2018

(54) PORTABLE BATTERY CHARGER

(71) Applicant: LG ELECTRONICS INC., Seoul (KR)

(72) Inventors: Hyunseok OH, Seoul (KR); Myonghoon KIM, Seoul (KR); Kyungik LEE, Seoul (KR); Sewon JANG, Seoul (KR)

(73) Assignee: LG ELECTRONICS INC., Seoul (KR)

(21) Appl. No.: 15/487,202

(22) Filed: Apr. 13, 2017

(30) Foreign Application Priority Data
Dec. 14, 2016 (KR) 10-2016-0170305

(51) Int. Cl. H02J 7/00

(52) U.S. Cl. CPC H02J 7/0042; H02J 7/0047

(57) ABSTRACT

A portable battery charger includes a rechargeable battery, a control board electrically connected with the rechargeable battery so as to control charge and discharge of the rechargeable battery, a middle case including an accommodation portion for accommodating the rechargeable battery and the control board mounted therein, a first case and a second case, which are coupled to the middle case and define the outer appearance of the portable battery charger, coupling hooks provided at a first edge and a second edge of the first case and including hook projections provided at respective ends thereof, coupling grooves formed in a first edge and a second edge of the second case so that the coupling hooks are inserted into the coupling grooves, and overflow holes formed in the coupling grooves so as to be open toward the middle case so that the hook projections are inserted into the overflow holes.

### CROSS-REFERENCE TO RELATED APPLICATION

This application claims the benefit of Korean Patent Application No. 10-2016-0170305, filed on Dec. 14, 2016, which is hereby expressly incorporated by reference in its entirety.

### BACKGROUND OF THE INVENTION

### Field of the Invention

The present invention relates to a portable battery charger.

### Discussion of the Related Art

Terminals may be generally classified as mobile/portable terminals or stationary terminals based on whether terminals are movable. Mobile terminals may also be classified as handheld terminals or vehicle mounted terminals based on whether a user can directly carry the terminal.

Mobile terminals have become increasingly more functional. Examples of such functions include data and voice communications, capturing images and video via a camera, recording audio, playing music files via a speaker system, and displaying images and video on a display. Some mobile terminals include additional functionality which supports game playing, while other terminals are configured as multimedia players. More recently, mobile terminals have been configured to receive broadcast and multicast signals which permit viewing of content such as videos and television programs.

As the functions of the terminal have become more diverse, the terminal is implemented in the form of a multimedia player provided with such complex functions as capturing a picture or a video, reproducing a music or video file, gaming, broadcast reception and the like.

In order to support and increase the functionality of the terminal, the improvement of structural part and/or software part of the terminal may be considered.

### SUMMARY OF THE INVENTION

Accordingly, the present invention is directed to a portable battery charger that substantially obviates one or more problems due to limitations and disadvantages of the related art.

An object of the present invention is to provide a portable battery charger that includes a case having an improved grip feeling.

Another object of the present invention is to provide a portable battery charger that has design unity even when the size or shape thereof varies depending on charging capacity.

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

To achieve the objects and other advantages and in accordance with the purpose of the invention, as embodied and broadly described herein, a portable battery charger includes a rechargeable battery, a control board electrically connected with the rechargeable battery so as to control charge and discharge of the rechargeable battery, a middle case including an accommodation portion for accommodating the rechargeable battery and the control board mounted therein, a first case and a second case coupled to the middle case in order to define an outer appearance of the portable battery charger, coupling hooks provided at a first edge and a second edge of the first case and including hook projections provided at respective ends thereof, coupling grooves formed in a first edge and a second edge of the second case so that the coupling hooks are inserted into the coupling grooves, and overflow holes formed in the coupling grooves so as to be open toward the middle case so that the hook projections are inserted into the overflow holes.

The portable battery charger may further include coupling holes formed in a first edge and a second edge of the middle case so that the coupling hooks pass through the coupling holes.

The middle case may further include edge wings extending from the first edge and the second edge thereof and disposed between the first case and the second case, and the coupling holes may be formed in the edge wings.

The portable battery charger may further include an adhesive agent injected into the coupling grooves so as to adhere to the coupling hooks, a portion of the adhesive agent flowing out of the overflow holes so as to adhere to the middle case.

The portable battery charger may have a hexagonal column shape, the middle case may include a first surface and a second surface corresponding to an upper surface and a lower surface of the hexagonal column, the first surface and the second surface of the middle case being exposed to an outside, and the first case and the second case may form side surfaces of the hexagonal column.

The portable battery charger may further include coupling slits formed in peripheral portions of the first surface and the second surface, and coupling ribs extending from the first case and the second case so as to be inserted into the coupling slits.

The accommodation portion may include a board accommodation portion in which the control board is mounted, a battery accommodation portion in which the rechargeable battery is accommodated, the battery accommodation portion having an opening formed in a bottom thereof, and a partition wall for partitioning the battery accommodation portion and the board accommodation portion.

The rechargeable battery may be provided with an elastic pad attached to a portion thereof that is exposed through the opening in the battery accommodation portion.

The portable battery charger may further include a sensor hole formed in the partition wall, and a temperature sensor extending from the control board and attached via the sensor hole to a portion of the rechargeable battery that is exposed through the opening in the battery accommodation portion.

The portable battery charger may further include board ribs protruding from the board accommodation portion to a bottom surface of the control board, and the number of board ribs may be three or more.

The board ribs may include a first board rib including a boss into which a screw is fastened after penetrating the control board, and a second board rib for supporting the bottom surface of the control board in a non-securing manner.

The portable battery charger may further include a switch mounted to the control board, a top button inserted into a button hole formed in the first case, and an actuator extending from the top button to the switch, and the board ribs may include a third board rib for supporting a bottom surface of the switch.

The portable battery charger may further include a connector mounted to the control board and including an elastic clip for securing an external cable, and a connector rib protruding from a portion of the middle case corresponding to a position of the connector, and the connector rib may have an opening in a portion thereof corresponding to a position of the elastic clip.

The portable battery charger may further include a switch mounted to the control board, a button hole formed in one selected from among the middle case, the first case and the second case, a top button inserted into the button hole so as to cover the button hole, and an actuator extending from the top button to the switch.

The portable battery charger may further include a button hook extending from the top button and configured to be hooked by a peripheral portion of the button hole.

The portable battery charger may further include a plurality of button ribs extending from the peripheral portion of the button hole in an inward direction of the button hole so as to support a bottom surface of the top button, and the button ribs may have openings formed in portions thereof corresponding to positions of the button hook and the actuator.

The button ribs may be connected at ends thereof to each other.

The button ribs may further include button support protrusions protruding from the ends of the button ribs toward the top button.

The portable battery charger may further include an elastic ring disposed between a peripheral portion of the button hole and the top button.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings:

FIG. 1 is a perspective view illustrating a portable battery charger according to an embodiment of the present invention;

FIG. 2 is an exploded perspective view illustrating the portable battery charger according to the embodiment of the present invention;

FIG. 3 is a sectional view illustrating a coupling part of the portable battery charger according to the embodiment of the present invention;

FIG. 4 is a perspective view illustrating a middle case of the portable battery charger according to the embodiment of the present invention;

FIG. 5 is a sectional view taken along line A-A in FIG. 1;

FIG. 6 is a sectional view taken along line B-B in FIG. 1;

FIG. 7 is an exploded perspective view illustrating a button of the portable battery charger according to the embodiment of the present invention;

FIG. 8 is an exploded perspective view of a portable battery charger according to another embodiment of the present invention;

FIG. 9 is an exploded perspective view of a portable battery charger according to a further embodiment of the present invention; and

FIG. 10 is a view illustrating a temperature sensor of the portable battery charger according to the embodiment in FIG. 8.

### DETAILED DESCRIPTION OF THE INVENTION

Description will now be given in detail according to exemplary embodiments disclosed herein, with reference to the accompanying drawings. For the sake of brief description with reference to the drawings, the same or equivalent components may be provided with the same reference numbers, and description thereof will not be repeated. In general, a suffix such as “module” and “unit” may be used to refer to elements or components. Use of such a suffix herein is merely intended to facilitate description of the specification, and the suffix itself is not intended to give any special meaning or function. In the present disclosure, that which is well-known to one of ordinary skill in the relevant art has generally been omitted for the sake of brevity. The accompanying drawings are used to help easily understand various technical features and it should be understood that the embodiments presented herein are not limited by the accompanying drawings. As such, the present disclosure should be construed to extend to any alterations, equivalents and substitutes in addition to those which are particularly set out in the accompanying drawings.

It will be understood that although the terms first, second, etc. may be used herein to describe various elements, these elements should not be limited by these terms. These terms are generally only used to distinguish one element from another.

It will be understood that when an element is referred to as being “connected with” another element, the element can be directly connected with the other element or intervening elements may also be present. In contrast, when an element is referred to as being “directly connected with” another element, there are no intervening elements present.

A singular representation may include a plural representation unless it represents a definitely different meaning from the context.

Terms such as “include” or “has” are used herein and should be understood that they are intended to indicate an existence of several components, functions or steps, disclosed in the specification, and it is also understood that greater or fewer components, functions, or steps may likewise be utilized.

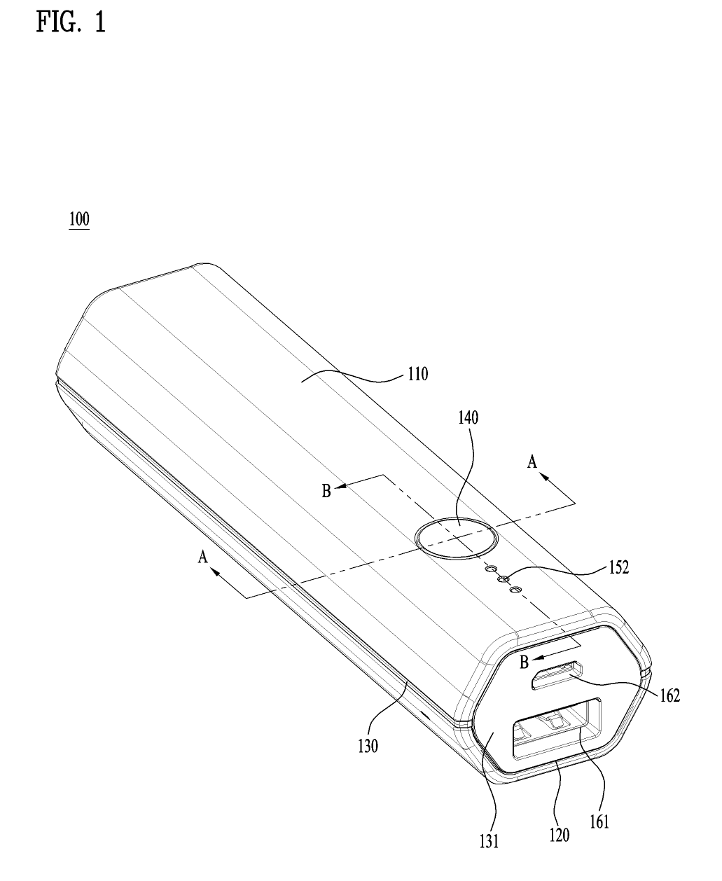

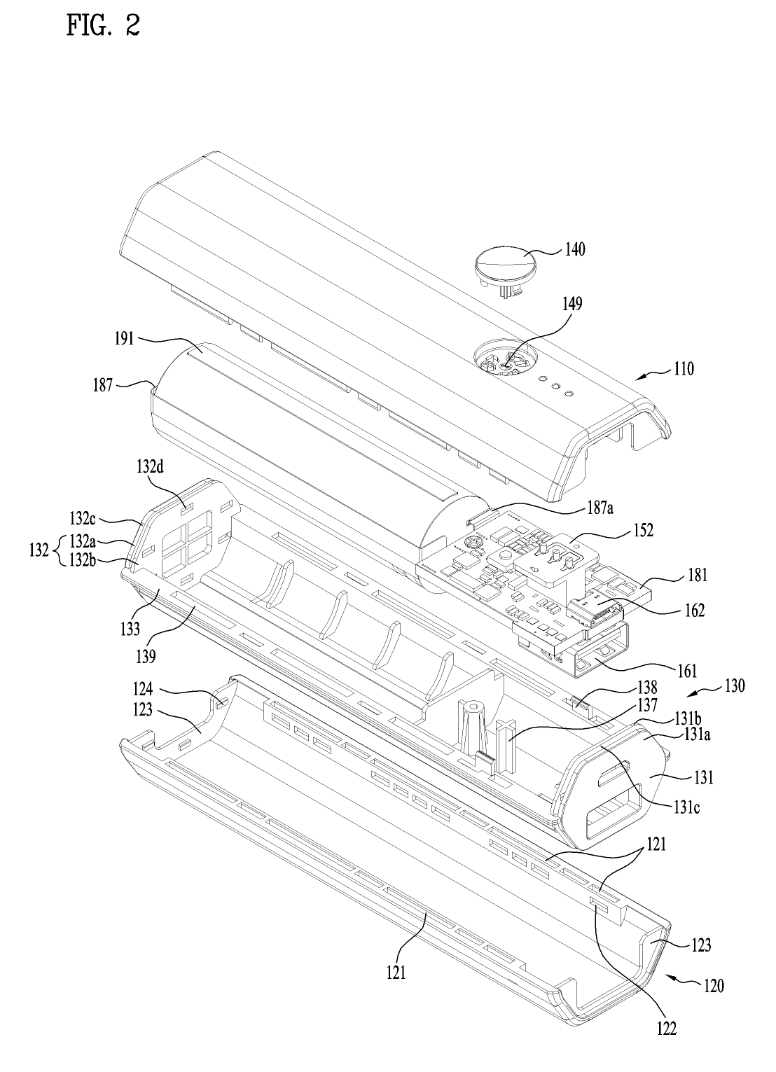

FIG. 1 is a perspective view illustrating a portable battery charger 100 according to an embodiment of the present invention, and FIG. 2 is an exploded perspective view illustrating the portable battery charger 100 according to the embodiment of the present invention.

Referring to FIG. 1, the portable battery charger 100 of the present invention has a hexagonal column shape. That is, the portable battery charger 100 includes an upper surface and a lower surface, each of which has a hexagonal shape, and six side surfaces, which extend between the upper surface and the lower surface in the vertical direction. The capacity of the portable battery charger 100 may be increased by widening two of the six side surfaces.

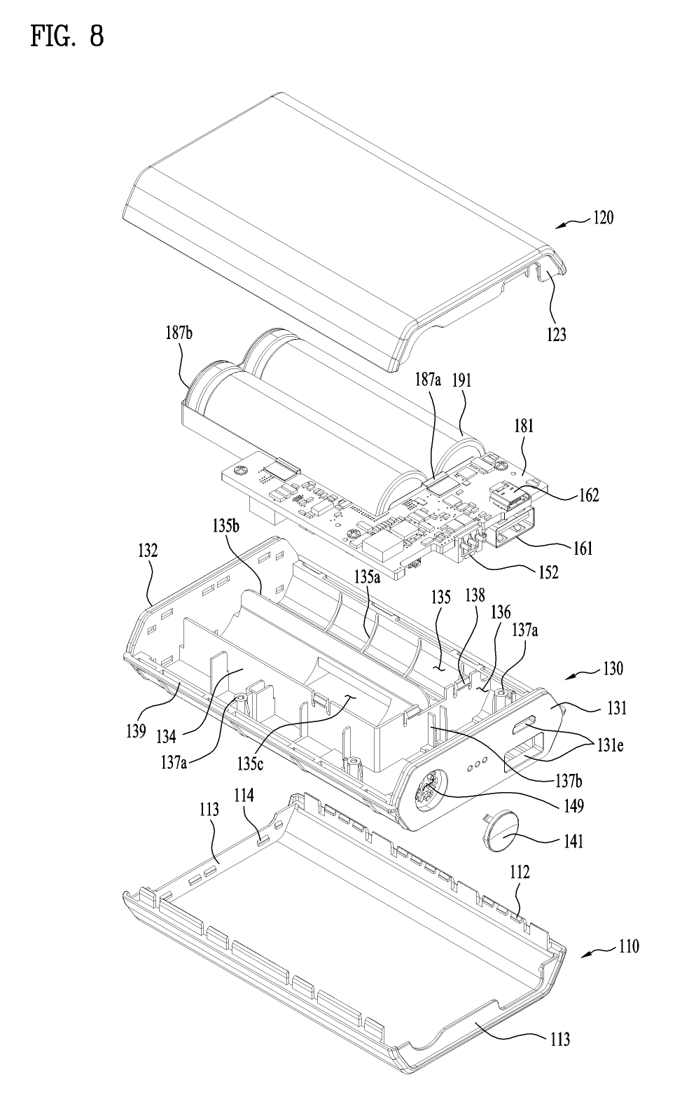

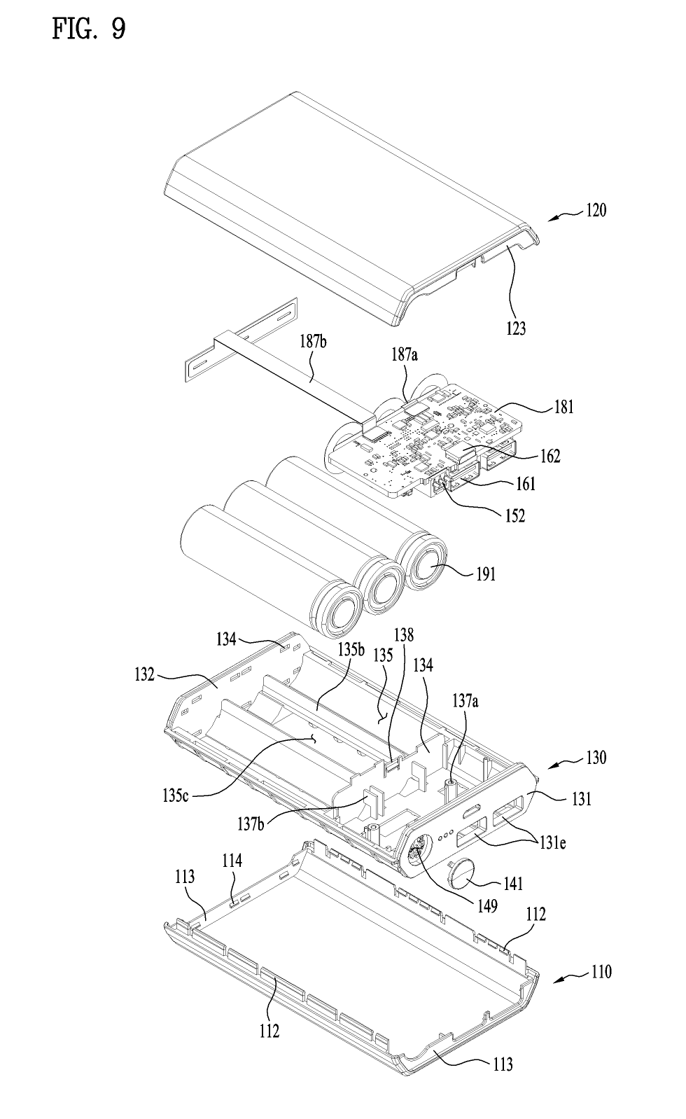

According to other embodiments, illustrated in FIGS. 8 and 9, the portable battery charger 100 may be structured such that two of the six sides of each of the upper surface 131 and the lower surface 132 are relatively lengthened in order to increase the capacity by increasing the number of rechargeable batteries 191.

That is, compared to a rectangular parallelepiped-shaped case, the case of the portable battery charger 100 is formed to have inclined surfaces at left and right portions thereof, which enable a user to hold the portable battery charger 100 comfortably and stably in the user's hand. Further, as shown in FIG. 2, in the case in which a rechargeable battery 191 having a cylindrical shape is laid laterally and loaded in the portable battery charger 100, the middle portion of each of the left surface and the right surface of the case is more prominent laterally. Therefore, a hexagonal column-shaped case is more effective in reducing the volume of the portable battery charger than a rectangular parallelepiped-shaped case.

Since a control board 181 has a plate shape, the control board 181 needs to be mounted in a space having the largest area in the width direction on the basis of the drawing. The hexagonal column-shaped case has a smaller volume than the rectangular parallelepiped-shaped case while satisfying such a control board mounting condition.

The portable battery charger 100 comprises a rechargeable battery 191 and a control unit for controlling charge and discharge of the rechargeable battery 191. The control unit functions to supply power from an external power source to the rechargeable battery 191 or to supply power stored in the rechargeable battery 191 to an external appliance.

The control unit may include a first connector 161 for electrical connection with the external appliance that receives power from the rechargeable battery 191 and a second connector 162 for electrical connection with the external power source that supplies power to the rechargeable battery 191. A standard USB port may be used for the first connector 161, and a micro-USB port may be used for the second connector 162.

USB version 2.0 or USB version 3.0 or higher may be employed for the first connector 161. The charging speed may vary depending on the version. When the control board 181 supports a higher version, the charging may be achieved more quickly. An embodiment illustrated in FIG. 9, which will be described later, may include two or more first connectors 161 having different standards so as to supply power to external appliances having different standards. In addition, there is an advantage in that power can be supplied to a plurality of external appliances at the same time via a plurality of first connectors 161.

The second connector 162 is configured to be electrically connected with the external power source so as to supply power to the rechargeable battery 191. The first connector 161 and the second connector 162 may be arranged in the vertical direction. The first connector 161 and the second connector 162 may be mounted to portions of the control board 181 that are oriented in different directions from each other. Although it is illustrated in the drawings that the first connector 161 is located at a relatively low position, the positions of the first connector 161 and the second connector 162 may be switched.

The cylindrical-shaped rechargeable battery 191, which is applied to the present invention, is provided with a positive (+) terminal and a negative (−) terminal on two opposite surfaces (i.e. the upper surface and the lower surface) thereof. In order to electrically connect the positive (+) terminal and the negative (−) terminal of the rechargeable battery 191 to the control board 181, an electrode 187a for electrical connection with the terminal located near the control board 181 may be formed to be relatively short, and an electrode 187b for electrical connection with the terminal located at the opposite side may extend a long length along the rechargeable battery 191.

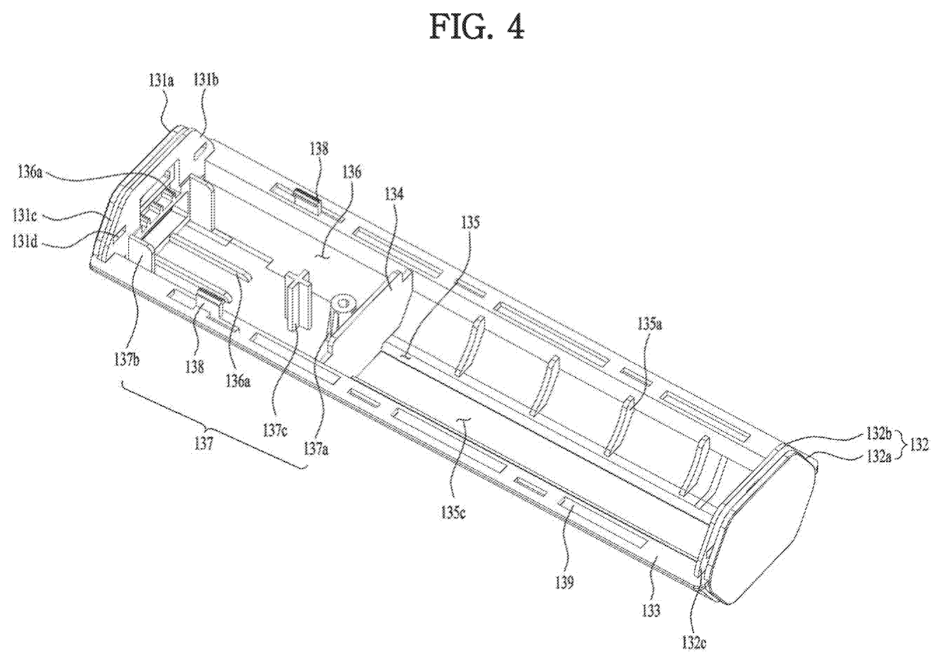

The case, which defines the outer appearance of the portable battery charger 100 of the present invention, includes a first case 110, a second case 120 and a middle case 130. The middle case 130 includes an accommodation portion 135, 136 (see FIG. 4) in which the rechargeable battery 191 and the control board 181 are mounted. The first case 110 and the second case 120 are coupled to the middle case 130 so as to cover the control board 181 and the rechargeable battery 191 disposed in the accommodation portion 135, 136.

The middle case 130 includes a first surface 131 and a second surface 132, which correspond to the upper surface and the lower surface of the hexagonal column-shaped portable battery charger 100. The first surface 131 and the second surface 132 are exposed to the outside. The middle case 130 further includes an open portion, which corresponds to some side surfaces of the hexagonal column-shaped portable battery charger 100. The open portion of the middle case 130 serves as the accommodation portion 135 and 136.

The accommodation portion 135, 136 of the middle case 130 is disposed between the first surface 131 and the second surface 132. Two opposite lateral ends of the accommodation portion 135 and 136 are referred to as a first edge and a second edge. The first edge and the second edge extend in a direction perpendicular to the first surface 131 and the second surface 132. As shown in FIG. 2, the first edge and the second edge of the middle case 130 may further include edge wings 133, which extend outwards from the first and second edges.

In this embodiment, the first case 110 is coupled to the top region of the accommodation portion 135 and 136, and the second case 120 covers the bottom surface of the middle case 130. However, the positions of the first case 110 and the second case 120 may be switched. The first case 110 forms three side surfaces of the hexagonal column, and the second case 120 forms the three remaining side surfaces of the hexagonal column.

As a result of the first and second edges of the first case 110 and the first and second edges of the second case 120 being brought into contact with each other, all of the side surfaces of the hexagonal column are formed. The edge wings 133 of the middle case 130 may be located between the first and second edges of the first case 110 and the first and second edges of the second case 120, and may be exposed to the outside, as shown in FIG. 1.

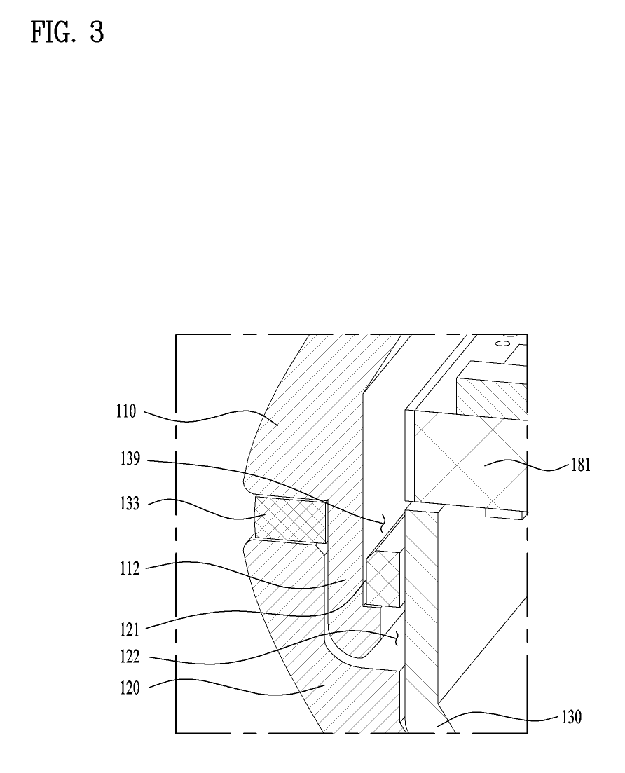

The first case 110 and the second case 120 may include coupling hooks 112 and coupling grooves 121, respectively, for engagement therebetween. FIG. 3 is a sectional view illustrating a coupling part of the portable battery charger 100 according to the embodiment of the present invention, in which the coupling hooks 112 protrude from the first edge and the second edge of the first case 110 and in which the coupling grooves 121 are formed in the first edge and the second edge of the second case 120.

Each of the coupling hooks 112 is provided with a hook projection at an end thereof that is configured to be inserted into a respective coupling groove 121 and to be hooked in an overflow hole 122, which extends inwards from the coupling groove 121, with the result that the first case 110 and the second case 120 are engaged with each other. The middle case 130, as shown in FIG. 3, further includes coupling holes 139 formed in the edge wings 133. The coupling hooks 112, protruding from the first case 110, are passed through the coupling holes 139 in the middle case 130 and are then inserted into the coupling grooves 121 in the second case 120. That is, the coupling hooks 112 secure the first case 110, the middle case 130 and the second case 120 to each other at the same time.

The first case 110, the middle case 130 and the second case 120 are secured to each other by the coupling hooks 112 hooked in the overflow holes 122; however, there may be further provided an adhesive agent, which is injected into the coupling grooves 121, in order to ensure more stable engagement. The adhesive agent adheres to the coupling hooks 112 inserted into the coupling grooves 121, and consequently prevents the coupling hooks 112 from escaping from the coupling grooves 121. A portion of the adhesive agent may flow out of the overflow holes 122, whereby the middle case 130 and the second case 120 may be attached to each other.

The first surface 131 and the second surface 132 of the middle case 130 are also coupled to the first case 110 and the second case 120. FIG. 4 is a perspective view illustrating the middle case 130 of the portable battery charger 100 according to the embodiment of the present invention. Referring to FIG. 4, the first surface 131 and the second surface 132 have coupling slits 131c and 132c formed in the peripheral portions thereof. Described in detail, the first surface 131 and the second surface 132 are respectively divided into an external surface 131a and 132a and an internal surface 131b and 132b, and coupling ribs 113 and 123, which extend from the first case 110 and the second case 120, are fitted into the coupling slits 131c and 132c, which are formed between the internal surface and the external surface of the first surface 131 and between the internal surface and the external surface of the second surface 132.

The coupling ribs 113 and 123, as shown in FIG. 2, are provided with protrusions 124. The protrusions 124 are configured to be inserted into locking holes 131d and 132d, which are formed in the internal surfaces 131b and 132b of the first surface 131 and the second surface 132 of the middle case 130, thereby preventing the first case 110 or the second case 120 from being separated from the middle case 130.

The accommodation portion 135 and 136 of the middle case 130 includes a board accommodation portion 136, in which the control board 181 is mounted, a battery accommodation portion 135, in which the rechargeable battery 191 is accommodated, and a partition wall 134 for partitioning the board accommodation portion 136 and the battery accommodation portion 135. The partition wall 134 functions not only to secure the rechargeable battery 191, but also to prevent the terminal of the rechargeable battery 191 from directly touching the control board 181.

The battery accommodation portion 135 includes support ribs 135a, which protrude to correspond to the shape of the rechargeable battery 191 so as to stably support the rechargeable battery 191. The bottom of the battery accommodation portion 135 is open, thereby preventing the thickness of the portable battery charger 100 from becoming large due to overlapping of the middle case 130 and the second case 120, reducing the weight of the portable battery charger 100, and reducing the amount of material (injection-molded material) used to manufacture the portable battery charger 100.

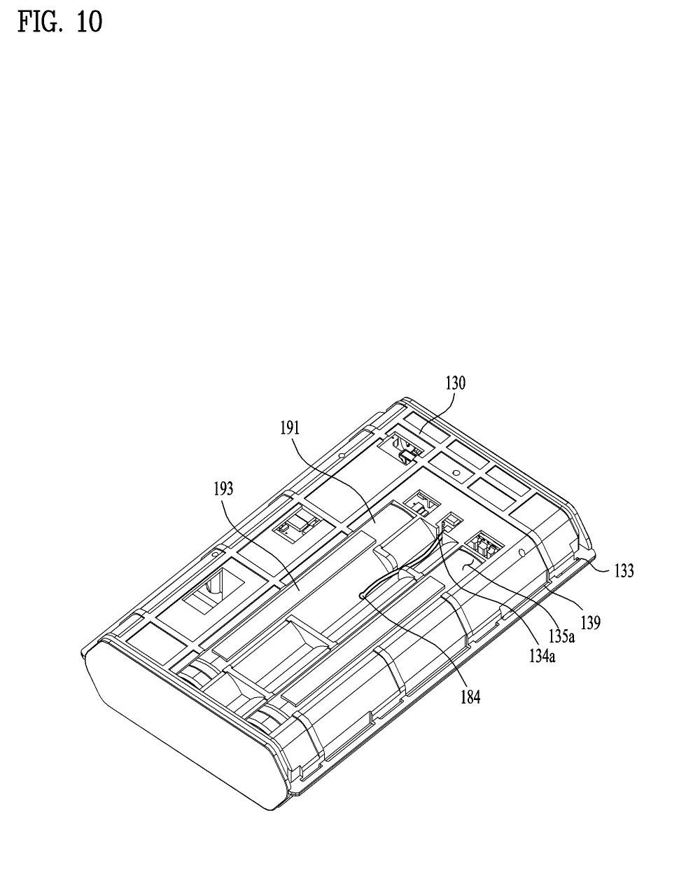

In order to absorb shocks due to direct contact between the second case 120 and a portion of the rechargeable battery 191 that is exposed through the opening of the battery accommodation portion 135, an elastic pad 193 may be attached to the rechargeable battery 191 (see FIG. 10). The elastic pad 193 may be additionally attached to a portion of the rechargeable battery 191 that comes into contact with the first case 110.

The control board 181 is located at a position that is spaced apart from the bottom of the board accommodation portion 136, and is seated on board ribs 137, which protrude from the bottom of the board accommodation portion 136. The number of board ribs 137 may be three or more so that the control board 181 is stably mounted in the board accommodation portion 136 without being inclined.

The board ribs 137 in this embodiment includes a first board rib 137a, to which the control board 181 is fastened by means of a screw 189, and a second board rib 137b, which is disposed so as to be spaced apart from the first board rib 137a.

The control board 181 is stably secured to the first board rib 137a by the screw 189 that is fastened into the first board rib 137a from the upper side of the control board 181. Although the control board 181 is not directly secured to the second board rib 137b, the second board rib 137b supports the bottom surface of the control board 181, and consequently more securely support the control board 181 together with the first board rib 137a. In this embodiment, the number of second board ribs 137b may be two so as to support the control board 181 in a balanced manner together with the first board rib 137a.

The middle case 130 may further include board hooks 138 for securing the edge portions of the control board 181. The board hooks 138, as shown in FIG. 4, may protrude from the first edge and the second edge of the middle case 130, or may protrude from the internal surface 131b of the first surface 131 or from the partition wall 134 of the accommodation portion (refer to FIG. 8). As a result of the screw 189 and the board hooks 138 preventing the control board 181 from being separated from the board ribs 137, the control board 181 is stably secured to the board accommodation portion 136.

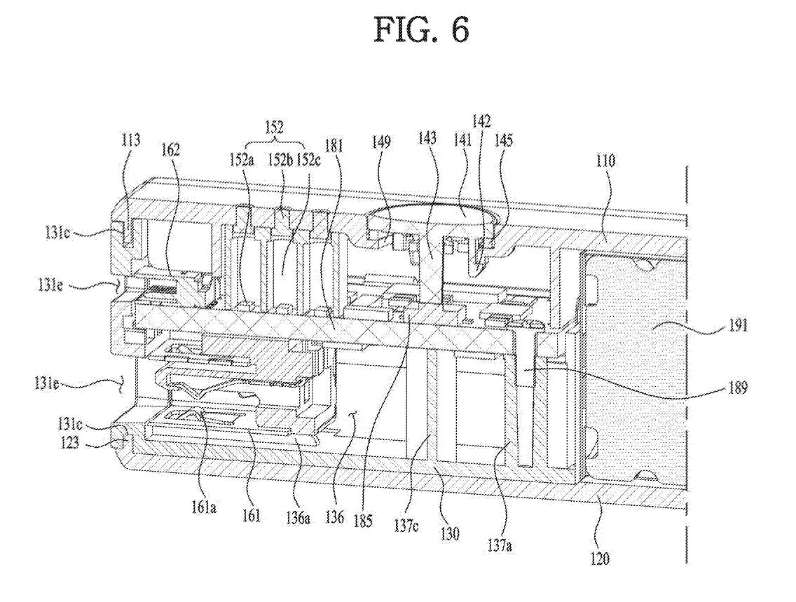

The first surface 131, which is disposed adjacent to the board accommodation portion 136, may have openings 131e therein, through which the first connector 161 and the second connector 162 mounted to the control board 181 are exposed to the outside. The board accommodation portion 136 may further include connector ribs 136a so that the first connector 161 and the second connector 162 are stably disposed in the openings 131e. The first connector 161 includes an elastic clip 161a (refer to FIG. 6) for securing the terminal inserted into the first connector 161. The connector ribs 136a may be located at positions at which interference with the movement of the elastic clip 161a is avoided.

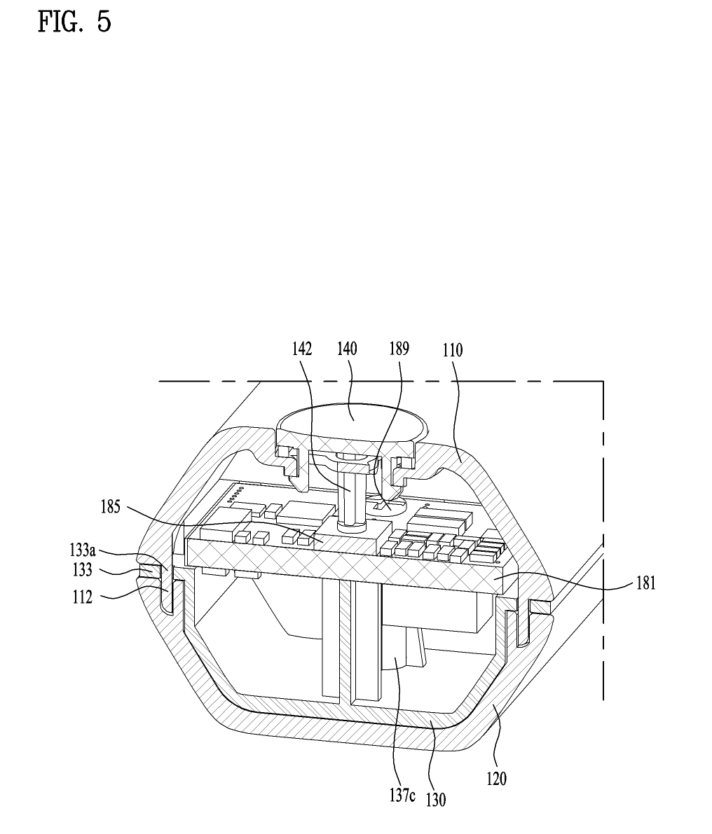

FIG. 5 is a sectional view taken along line A-A in FIG. 1, and FIG. 6 is a sectional view taken along line B-B in FIG. 1. The portable battery charger 100 further comprises a button 140 for controlling ON/OFF operation of the portable battery charger 100. In this embodiment, the button 140 is disposed at the first case 110; however, the button 140 may be disposed at the first surface 131 of the middle case 130 in other embodiments (refer to FIGS. 8 and 9).

Since the first surface 131 in the embodiments in FIGS. 8 and 9 has a larger area than that of the first surface in the embodiment in FIG. 1, it is possible to locate the button 140 at the first surface 131. However, the area of the first surface 131 in this embodiment is not large enough to allow additional arrangement of the button 140 in addition to the first and second connectors 161 and 162. Therefore, in this embodiment, the button 140 is located at the first case 110.

The button 140 includes a top button 141, which is inserted into a button hole 149 formed in the first case 110, and a switch 185, with which an end of an actuator 143 extending from the top button 141 is in contact. The switch 185 is mounted to the control board 181. When the user presses the button 140, the force is applied in the direction perpendicular to the surface of the control board 181. In order to ensure that the control board 181 is stably seated in the board accommodation portion 136, a third board rib 137c is provided at a position in the board accommodation portion 136 that is opposite the position of the switch 185. This third board rib 137c supports the control board 181 against the force applied to the control board 181 when the button 140 is pressed.

The top button 141 is received in the button hole 149 such that the top surface thereof is exposed to the outside, and includes an actuator 143, which extends from the center of the bottom surface of the top button 141 toward the switch 185 mounted to the control board 181, and a button hook 142, which protrudes from a marginal portion of the top button 141. The button hook 142 extends toward the interior of the button hole 149 and is hooked by the peripheral portion of the button hole 149, thereby preventing the button 140 from being separated from the button hole 149.

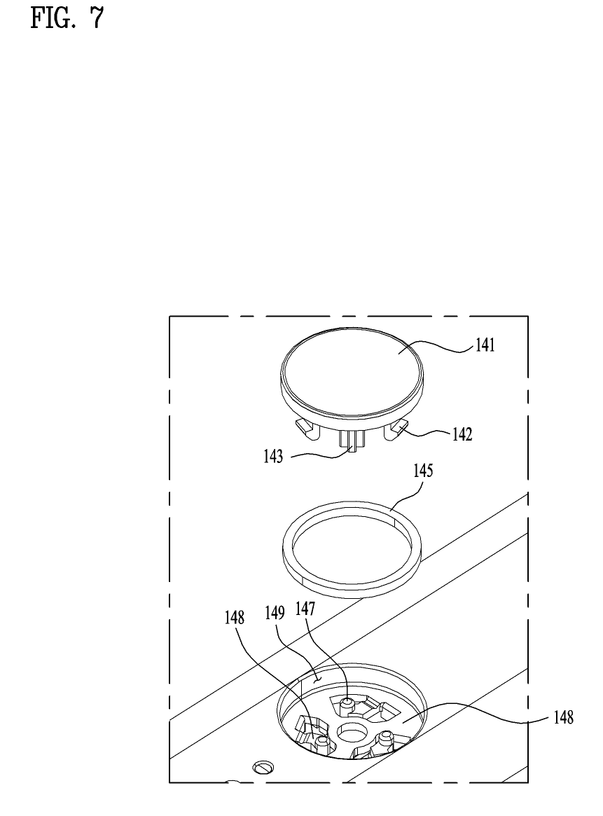

FIG. 7 is an exploded perspective view illustrating the button 140 of the portable battery charger 100 according to the embodiment of the present invention. Referring to FIG. 7, the button hole 149 is provided with a plurality of button ribs 148, which extend from the peripheral portion of the button hole 149. The button ribs 148 may be connected to each other so as to prevent the top button 141 from falling into the button hole 149. The button ribs 148 may be provided with button support protrusions 147, which protrude toward the bottom surface of the top button 141 so as to support the top button 141. The button ribs 148 are disposed at positions at which interference with the button hook 142 and the actuator 143 is avoided. Therefore, the button hook 142 and the actuator 143 extend through the spaces between the button ribs 148.

The top button 141 returns to its original position due to the restoring force of the switch 185 when the pressing force is eliminated. In order to reinforce the restoring force and provide a better pressing sensation to the user, there may be further provided an elastic ring 145, which is located between the button hole 149 and the top button 141. The elastic ring 145 is made of a material having elasticity, e.g. a sponge. The top button 141 may have a groove formed at a position in the bottom surface thereof that corresponds to the position of the elastic ring 145.

Referring to FIG. 6, the portable battery charger 100 further comprises an indicator 152, which is mounted to the control board 181. The indicator 152 includes a light-emitting diode (LED) 152a for emitting light, an optical path portion 152c, through which the light emitted from the LED 152a passes, and a scattering portion 152b for scattering light. The LED 152a may be provided in a plural number, and the user may recognize the state of charge of the rechargeable battery 191 based on the number of LEDs 152a that are emitting light. Alternatively, the indicator 152 may provide other information to the user by varying the color of the light emitted from the LEDs 152a. The optical path portion 152c may also be provided in a plural number corresponding to the respective LEDs 152a. In order to avoid interference between the LEDs 152a, the optical path portions 152c are partitioned by partition walls. The scattering portion 152b, which is inserted into each of the optical path portions 152c, scatters light so that the light is evenly radiated. Although the indicator 152 in this embodiment is located at the first case 110, it may alternatively be located at the first surface 131 in other embodiments, illustrated in FIGS. 8 and 9.

FIG. 8 is an exploded perspective view of a portable battery charger 100 according to another embodiment of the present invention, and FIG. 9 is an exploded perspective view of a portable battery charger 100 according to a further embodiment of the present invention. The embodiment in FIG. 8, which is adapted for two rechargeable batteries 191, has a capacity that is twice as large as that of the embodiment in FIG. 1, and the embodiment in FIG. 9, which is adapted for three rechargeable batteries 191, has a capacity that is three times as large as that of the embodiment in FIG. 1.

According to the embodiments illustrated in FIGS. 8 and 9, with the increase in the number of the rechargeable batteries 191, the dimensions of the battery accommodation portion 135, in which the rechargeable batteries 191 are mounted, increases, the size of the control board 181 also increases in order to control the amount of charging power and the amount of discharging power of the two rechargeable batteries 191, and consequently the dimensions of the board accommodation portion 136 also increase.

As a result, with the increase in the number of the rechargeable batteries 191, the portable battery charger 100 is expanded in the lateral direction. Further, with the increase in the size of the control board 181, the portable battery charger 100 is also expanded in the longitudinal direction of the hexagonal column. However, in order to prevent excessive expansion in the longitudinal direction of the hexagonal column, as shown in FIG. 8, the control board 181 may be formed in an L shape. In this case, the number of board ribs 137 may be increased so as to stably secure the control board 181. In addition, there may be further provided battery support ribs 135b, which are disposed between the plurality of rechargeable batteries 191 in order to define the mounting positions of the respective rechargeable batteries 191.

Unlike the previously described embodiment, the embodiments in FIGS. 8 and 9 are constructed such that the button 140 and the connectors 161 and 162 are located at the first surface 131. Further, according to the embodiment in FIG. 9, when the capacities of the rechargeable batteries 191 are relatively large, the first connector 161 may be provided in a plural number. In this case, different kinds of standard connectors (e.g. USB 2.0 and USB 3.0) may be employed.

Unlike the previously described embodiment, the embodiments in FIGS. 8 and 9 are constructed such that the first case 110 including the coupling hooks 112 is located below the middle case 130 and the second case 120 including the coupling grooves 121 is located above the middle case 130. In other words, the positions of the coupling grooves 121 and the coupling hooks 112 may be switched.

FIG. 10 is a view illustrating a temperature sensor 184 of the portable battery charger 100 according to the embodiment in FIG. 8. The portable battery charger 100 according to the embodiment may further comprise a temperature sensor 184 in order to prevent explosion due to overheating. The control board 181 may cut off power when the temperature of the rechargeable batteries 191 detected by the temperature sensor 184 exceeds a predetermined level.

The temperature sensor 184 is in contact with at least one of the rechargeable batteries 191 and is electrically connected with the control board 181. When the temperature sensor 184 is located on the surface of a corresponding one of the rechargeable batteries 191 that is exposed from the open upper portion of the battery accommodation portion 135, the temperature sensor 184 is electrically connected with the top surface of the control board 181. To the contrary, the temperature sensor 184 may be located on the surface of a corresponding one of the rechargeable batteries 191 that is exposed through an opening 135a in the battery accommodation portion 135. As shown in FIG. 10, a portion of the bottom of the battery accommodation portion 135 may be open in order to reduce the thickness thereof, and the temperature sensor 184 may be attached to the surface of a corresponding one of the rechargeable batteries 191 that is exposed through the opening 135a in the battery accommodation portion 135. In order to achieve electrical connection with the control board 181, a recess and a sensor hole 134a are formed in the partition wall, whereby the temperature sensor 184 is electrically connected with the control board 181 through the recess and the sensor hole 134a in the partition wall.

As is apparent from the above description, the present invention provides a portable battery charger that is formed to have a hexagonal column shape, leading to an improved grip feeling.

Further, unit cases are firmly assembled with each other to form a case by combining multiple kinds of coupling means while minimizing the use of screws, thereby reducing the possibility of damage and enhancing durability.

In addition, even when the size or shape of the portable battery charger is varied to meet a required capacity by varying the number of rechargeable batteries, the portable battery charger has design unity and the production of a product family design can be achieved.

The foregoing embodiments are merely exemplary and are not to be considered as limiting the present disclosure. The present teachings can be readily applied to other types of methods and apparatuses. This description is intended to be illustrative, and not to limit the scope of the claims.

What is claimed is:

1. A portable battery charger comprising:
a rechargeable battery;
a control board electrically connected to the rechargeable battery so as to control charge and discharge of the rechargeable battery;
a middle case including an accommodation portion to receive the rechargeable battery and the control board;
a first case coupled to the middle case, the first case including coupling hooks provided at a first edge and a second edge of the first case, each coupling hook including a hook projection at an end thereof; and
a second case coupled to the middle case, the second case including coupling grooves located in a first edge and a second edge of the second case such that the coupling hooks are inserted into the coupling grooves, each of the coupling grooves including an overflow hole open toward the middle case such that the hook projections are inserted into the overflow holes,
wherein the first case and the second case define an outer appearance of the portable battery charger.

2. The portable battery charger according to claim 1, wherein the middle case includes coupling holes located in a first edge and a second edge of the middle case, the coupling hooks passing through the coupling holes when the first case is coupled to the middle case.

3. The portable battery charger according to claim 2, wherein the middle case further includes edge wings extending from the first edge and the second edge of the middle case, the edge wings being disposed between the first case and the second case, and the coupling holes being located in the edge wings.

4. The portable battery charger according to claim 1, further comprising an adhesive agent located in the coupling grooves to adhere to the coupling hooks,
wherein a portion of the adhesive agent extends out of the overflow holes so as to adhere to the middle case.

5. The portable battery charger according to claim 1, wherein the portable battery charger has a shape of a hexagonal column,
wherein the middle case includes a first surface and a second surface corresponding to an upper surface and a lower surface of the hexagonal column, the first surface and the second surface of the middle case being externally exposed, and
wherein the first case and the second case form side surfaces of the hexagonal column.

6. The portable battery charger according to claim 5, wherein each of the first surface and the second surface includes coupling slits located in peripheral portions thereof, and
wherein each of the first case and the second case includes coupling ribs extending therefrom and inserted into the coupling slits of the first surface and the second surface.

7. The portable battery charger according to claim 1, wherein the accommodation portion includes a partition wall partitioning the accommodation portion into a battery accommodation portion in which the rechargeable battery is located and a board accommodation portion in which the control board is located, and
wherein the battery accommodation portion has an opening located in a bottom thereof.

8. The portable battery charger according to claim 7, further comprising an elastic pad attached to a portion of the rechargeable battery that is exposed through the opening in the battery accommodation portion.

9. The portable battery charger according to claim 7, wherein the partition wall includes a sensor hole located therein, and
wherein the portable battery charger further comprises a temperature sensor extending from the control board and attached via the sensor hole to a portion of the rechargeable battery that is exposed through the opening in the battery accommodation portion.

10. The portable battery charger according to claim 7, wherein the middle case includes a plurality of board ribs protruding from the board accommodation portion to a bottom surface of the control board.

11. The portable battery charger according to claim 10, wherein the plurality of board ribs includes:
a first board rib including a boss; and
a second board rib to support the bottom surface of the control board in a non-securing manner, and
wherein the portable battery charger further comprises a screw fastened to the boss of the first board rib, the screw penetrating through the control board.

12. The portable battery charger according to claim 10, wherein the first case includes a button hole,
wherein the portable battery charger further comprises:
a switch at the control board;
a top button inserted into the button hole in the first case; and
an actuator extending from the top button to the switch, and
wherein the plurality of board ribs includes a third board rib to support a portion of the control board located beneath the switch.

13. The portable battery charger according to claim 1, further comprising a connector mounted to the control board, the connector including an elastic clip configured to secure an external cable,
wherein the middle case includes a connector rib protruding from a portion thereof corresponding to a position of the connector, and
wherein the connector rib has an opening in a portion thereof corresponding to a position of the elastic clip.

14. The portable battery charger according to claim 1, wherein one of the first case, the second case, or the middle case includes a button hole, and
wherein the portable battery charger further comprises:
a switch at the control board;
a top button inserted into the button hole in the one of the first case, the second case, or the middle case; and
an actuator extending from the top button to the switch.

15. The portable battery charger according to claim 14, further comprising a button hook extending from the top button, the button hook being configured to be hooked to a peripheral portion of the button hole.

16. The portable battery charger according to claim 15, further comprising a plurality of button ribs extending from the peripheral portion of the button hole in an inward direction of the button hole so as to support a bottom surface of the top button,
wherein the button ribs have openings located in portions thereof corresponding to positions of the button hook and the actuator.

17. The portable battery charger according to claim 16, wherein the button ribs are connected at ends thereof to each other.

18. The portable battery charger according to claim 16, wherein the button ribs further include button support protrusions protruding from the ends of the button ribs toward the top button.

19. The portable battery charger according to claim 14, further comprising an elastic ring disposed between a peripheral portion of the button hole and the top button.

20. The portable battery charger according to claim 1, further comprising an indicator to represent an amount of battery charge of the rechargeable battery.
